(19) United States
(12) Patent Application Publication
(10) Pub. No.: US 2005/0186442 A1
(43) Pub. Date: Aug. 25, 2005

(54) Coating method and coating mixture

(76) Inventor: Georg Gros, Oppenau (DE)

Correspondence Address: FULBRIGHT & JAWORSKI, LLP, 666 FIFTH AVE, NEW YORK, NY, 10103-3198, US

(21) Appl. No.: 11/118,692

(22) Filed: Apr. 29, 2005

Related U.S. Application Data
(63) Continuation of application No. 09/980,182, filed on Jan. 7, 2002.

(30) Foreign Application Priority Data
Jun. 4, 1999 (DE) 199 25 631.4

(51) Int. Cl. B05D 3/00; B32B 15/08

(52) U.S. Cl. 428/626; 427/487; 428/659

(57) ABSTRACT

A coating mixture and a method for applying a weldable anticorrosive coating to a metallic substrate.

This invention relates to a method of applying a weldable anticorrosive coating to a metallic substrate, in particular a body sheet for the automotive industry, as well as a coating mixture for performing this method.

Weldable protective coatings as mentioned above on the basis of inorganic pigment particles, and organic polymers are known and described for instance in DE-C-34 12 234.

EP-B-298 409 describes such coatings for steel sheet, which coatings have a layer of silicic acid and a cured organic matrix, which was obtained from an epoxy resin and a polyvalent isocyanate by thermal cross-linkage.

EP-C-344 129 describes similar coatings, which are obtained by curing epoxy resins by means of amines, melamines, phenol resins and the like.

EP-A-761 320 describes coated steel sheets, which carry an organic protective layer which was produced from an aqueous solution by electrolytic polymerization of inorganic polymerizable organic compounds.

EP-A-659 855 describes an aqueous coating mixture, from which curable antirust coatings can be deposited.

All these known coating mixtures contain organic or aqueous solvents, which must be evaporated upon application. To achieve a durable resistance to chemicals and weathering influences as well as a sufficient rust protection, these coatings must be cured by heating. This has the disadvantage of a higher consumption of energy and the risk of the emission of volatile components to the environment by evaporation. Moreover, chemically cross-linked polymer coatings frequently tend to become brittle.

This means that the steel sheets provided with a thermally cured organic coating in the known manner are deformable only to a limited extent, for instance by deep-drawing or bevelling. In most cases, this requires a pretreatment with drawing oil. The required high curing temperatures can lead to structural changes in the substrate.

The known coating mixtures frequently contain zinc powder. Such mixtures tend to corrosion, which starts between the pigmented layer and the metallic, possibly zinc-coated substrate. On the other hand, a content of conductive components is required to achieve a weldable coating.

It was the object of the invention to provide a coating mixture and a coating method for corrodible metallic substrates, which provide a corrosion- and solvent-resistant slidable weldable coating which can be deformed together with the substrate without being damaged.

The invention proceeds from a mixture for applying an anticorrosive layer to a metallic substrate, comprising a polymeric organic binder, a low-molecular liquid compound to be subjected to free-radical polymerization, a compound forming radicals under the influence of actinic radiation, and a conductive pigment.

In accordance with the invention, there is furthermore proposed a coating method for a metallic substrate, which method is characterized in that the aforementioned mixture is applied to the surface of the substrate and the coating applied is irradiated with actinic radiation for such a period and with such an intensity that a firm, hard, tough corrosion-resistant layer is formed.

Actinic radiation is understood to be such radiation whose energy is sufficient for activating the polymerization initiator. Normally, it should at least have the energy or the frequency of visible light; short-wave visible or ultraviolet light is preferred. Naturally, any radiation of a shorter wavelength, and thus of a higher energy, can likewise be used. For instance, electron radiation may be used as well, which has the advantage that no photoinitiator is required.

The inventive coating mixture preferably is free of inert volatile solvents, in particular organic solvents or water.

The polymeric binder is solid and may be saturated itself. Preferably, the polymeric binder contains unsaturated polymerizable groups which in the case of the radiation-initiated polymerization of the polymerizable compound can react with the same and form an insoluble network.

Suitable binders include condensation resins, epoxy resins, poly(meth)acrylates, polyurethanes, polyesters, polyethers and other similar polymers or polymers derived therefrom. Preferred binders include epoxidized novolaks, bisphenol epichlorohydrin condensation products and esterification products of the above-mentioned resins or polymers with acrylic or methacrylic acid. When epoxidized novolaks are used, the same may be made on the basis of phenol, substituted phenols (for instance cresol) or also polyvalent, possibly substituted phenols or mixtures of the aforementioned phenols.

The low-molecular monomeric compound contains at least one polymerizable ethylenically unsaturated group. To achieve a rather good cross-linkage and thus insolubility and resistance of the layer to solvents, chemicals and weathering influences, at least part of the polymerizable compounds should contain at least two polymerizable groups. Preferably, the polymerizable compound is an ester of an αβ-unsaturated carboxylic acid with a di- or polyvalent, possibly also oligomeric alcohol. Esters of acrylic or methacrylic acid are preferred particularly. Apart from ester groups, the polymerizable compounds may also contain other functional groups, in particular ether, amide or urethane groups. Examples for suitable polymerizable compounds include dipropylene and tripropylene glycol di(meth)acrylate, 2-acetoacetyloxy ethyl methacrylate, hexanediol diacrylate, hydroxypropyl methacrylate, hydroxyethyl methacrylate, trimethylolpropane triacrylate.

As compounds forming radicals when irradiated, in particular photoinitiators, especially those can be used, which have a strong absorption in the spectral range of the radiation used, in particular of the near ultraviolet or short-wave visible light, i.e. with a wavelength approximately in the range from 180 to 700 nm. There can be used above all aromatic carbonyl compounds and the derivatives thereof, such as quinones, ketones and the ketals thereof, for example benzildimethylketal, benzoin, substituted benzoins and benzoin ethers, α-amino ketones; furthermore polynuclear heterocyclic compounds such as acridines, phenazines and the substitution products thereof as well as substituted phosphine oxides, for instance bisacyl phosphine oxides.

To prevent a premature polymerization of the coating mixtures, the same normally contain small amounts of polymerization inhibitors, for instance hydroquinone and the derivatives thereof and tert-butyl phenols. Normally, such inhibitors are already included in all commercially available polymerizable compounds.

Normally, the mixtures furthermore contain coating aids, for instance surface-active substances, in particular polysiloxanes, silanes and silicon-free oligomeric or polymeric surfactants. They can furthermore contain adhesion promoters, soluble corrosion inhibitors, dyes and color pigments.

Another important component are inorganic pigments, in particular anticorrosive or antirust pigments, for instance oxides, phosphides or phosphates of iron or aluminum, and other conductive pigments, for instance graphite-mica pigments.

The amounts of the components of the coating mixture lie within the following ranges:
Binder: generally 15 to 60, preferably 20 to 50, in particular 20 to 40 % by weight.
Polymerizable compound: generally 20 to 60, preferably 20 to 55, in particular 25 to 50 % by weight.
Pigment: generally 10 to 40, preferably 10 to 35, in particular 12 to 35 % by weight.
Photoinitiator: generally 5 to 30, preferably 8 to 25, in particular 8 to 20 % by weight.
Additives: generally 0.1 to 5, preferably 0.3 to 4, particularly preferably 0.4 to 3 % by weight.

The coating mixtures are generelly prepared by grinding the insoluble pigment particles together with the remaining soluble components to obtain a homogeneous viscous mass. The viscosity should lie in a range which allows a uniform application to form a thin layer having a thickness of about 2 to 8 μm. The viscosity can be adjusted by choosing the kind and quantity above all of the binder and of the polymerizable compound. In general, it lies in the range from 1000 to 10000 mPas.

The metallic substrate to be coated preferably is a strip or sheet which mostly consists of steel and has a thickness in the range from about 0.2 to 1.6 mm. Normally, the strip surface is electrolytically or hot-dip zinc-coated and/or chromatized or subjected to a similar pretreatment. To the surface pretreated in this way, the weldable coating in accordance with the invention is then applied. In general, the strip or sheet is unwound onto rolls, so-called coils. To apply the inventive coating, the coil is wound off, and upon coating is wound up again. Application is expediently effected in a continuous process, in which the strip runs through a coating station and thereafter through a curing station. Coating can be effected by spraying, by means of slot nozzles or by means of rollers. Roller coating is preferred in general. Coating is preferably effected at room temperature or a temperature slightly above room temperature, i.e. at temperatures in the range from about 20 to 40° C., the material and the substrate preferably having a temperature of 40 to 50° C. The layer thickness can generally be 2 to 8, preferably 3 to 7 μm. Since the coating compound preferably is free of solvent, this corresponds substantially to the layer thickness of the cured layer.

Upon coating, curing is effected, advantageously by passing through a curing station. In an inert gas atmosphere, for instance under nitrogen, and at a distance of few centimeters, the strip is passed below a radiation source which corresponds to the entire width of the strip. The strip speed depends on the layer thickness, the light sensitivity of the layer, the lamp distance and the lamp performance. It furthermore depends on whether irradiation is effected in air or in nitrogen. If desired, it can be accelerated by providing two or more radiation sources disposed one behind the other. As radiation sources, UV light sources such as gas discharge lamps, xenon lamps or sodium vapor lamps are preferably used, which have emission maxima in the spectral range from about 100 to 700 nm, in particular in the range from 200 to 600 nm. Lamps substantially emitting in the short-wave visible range from about 400 to 550 nm can also be used. In principle, radiation of higher energy, for instance electron radiation, can also be used for curing. Irradiation, like coating, is effected at ambient temperatures, which do not lie much above room temperature, i.e. in general not above about 50° C. The irradiated layer surface reaches temperatures up to about 80° C. If an additional postcure is desired, the same can be effected by a subsequent brief passage through a drying oven, which has a temperature up to about 250° C., and the surface temperature of the strip can reach about 150 to 160° C. with a dwell time of 30 seconds. In this way, the corrosion resistance can still be increased; however, such postcure is generally not required.

In any case, the layer composition and the curing conditions should be chosen such that a hard, firm, corrosion-resistant layer is obtained, which is, however, sufficiently tough, so that a deformation of the substrate, for instance of the steel sheet, is ensured without brittle cracks in the anticorrosive layer.

The processing of the anticorrosive layer by the inventive method provides for a wide variation of the layer thickness within the range indicated above. The layer adheres to the substrate firmly and durably; it can be overpainted as usual, for instance by cationic dip-coating, and has a smooth, slidable surface. With a thickness of the cured layer of 3 um, up to 900 welding spots per electrode are achieved.

In the main field of application of the inventive method, the production and processing of body sheets for the automotive industry, the inventive coating of the sheets (coils) is advantageously effected at the sheet manufacturer after the pre-treatment. The sheets are then protected against corrosion (“coil-coated steel”) and in this stage can be transported to the finisher, in general to the car manufacturer, and be stored. They are deformed as desired and subjected to a usual dip-coating as priming. To this prime coat, a finishing paint will then be applied at a later date. In general, the prime coat cannot reach all parts of the deformed steel sheet. Due to the inventive coating, the surface still remains protected against corrosion despite deforming and welding.

In the following examples, preferred embodiments of the inventive method are explained. Amounts and ratios are understood to be in weight units, unless otherwise indicated. The amounts are usually indicated in parts by weight (pbw).

### EXAMPLE 1

A mixture of

| | | |
|---|---|---|
| 20 | pbw | of a novolak epoxy resin esterified with acrylic acid |
| | | (Viaktin ® VTE 6152, 65% in tripropylene glycol |
| | | diacrylate, Vianova Resins), |
| 15 | pbw | of an aliphatic urethane acrylate |
| | | (Syntholux ® DRB 227, 65% in hydroxypropyl |
| | | methacrylate, Synthopol-Chemie), |
| 26.7 | pbw | acetoacetyloxy ethyl methacrylate |
| | | (Lonzamon ® AAEMA, Lonza AG, Basel), |
| 8 | pbw | magnetizable iron oxide |
| | | (Magnetschwarz ® S 0045, BASF AG), |
| 12 | pbw | iron phosphide |
| | | (Ferrophos ® HRS 2132, Occidental Chemical Corp., |
| | | Niagara, USA), |
| 3 | pbw | aluminum triphosphate |
| | | (K-White 105, Teikoku Kako Co., Osaka), |
| 6 | pbw | benzildimethylketal |
| | | (Irgacure ® 651, Ciba-Geigy AG), |
| 1 | pbw | Irgacure ® 1850 (Ciba-Geigy), mixture of 50% |
| | | 1-hydroxy-cyclohexyl-phenyl ketone and 50% |
| | | bis(2,6-dimethoxybenzoyl-2,4,4-trimethylpentyl-phosphine |
| | | oxide), |
| 8 | pbw | 1-hydroxy-cyclohexyl-phenyl ketone (Irgacure ® 184), and |
| 0.3 | pbw | substituted phosphine oxide (Irgacure ® 819) |

was thoroughly ground on a roller mill for two hours, until a homogeneous viscous mixture was obtained. The viscosity was 100 s outflow time from a flow cup in accordance with European standard EN ISO 2431 (CEN). In a roller coating device, with a rate of passage of 20 m/min, the mixture was applied to a degreased and dried sheet of electrolytically zinc-coated and chromatized steel with a thickness of 0.8 mm and a width of 20 cm, such that a coating with a thickness of 3 μm (4 g/m²) was obtained. Directly thereafter, the sheet was passed through a curing zone, where it was irradiated at a distance of 8 cm by means of two succeeding UV gas discharge lamps of the firm IST, type CK-1 (gallium-doped) and CK (mercury-doped), each with a performance of 160 W/cm and emission maxima in the range from 200 to 600 nm under a nitrogen atmosphere with 3000 ppm residual oxygen, the surface temperature of the coating maximally reaching 80° C. The cured coating was resistant to butanone; when bevelling the coated sheet by an angle of 90°, the sheet showed no signs of damages or cracks in the anticorrosive layer. The layer surface was smooth and slidable. Even after 360 hours salt spray test according to DIN 50021 it was still undamaged and showed no signs of red rust.

### EXAMPLE 2

As described in Example 1, a cured antirust layer was produced on a zinc-coated and chromatized steel sheet. The coating compound contained the following components:

| | | |
|---|---|---|
| 16 | pbw | of the aliphatic urethane acrylate indicated in Example 1 |
| | | (Syntholux ® ), |
| 16 | pbw | of an aliphatic urethane acrylate |
| | | (Viaktin ® VTE 6171, 60% in a cycloaliphatic ether |
| | | acrylate, Servocure ® RM-174), |
| 1.5 | pbw | unsaturated phosphoric acid ester |
| | | (Ebecryl ® 168, UCB Chemicals, Belgium); |
| 0.75 | pbw | of a trimethoxysilane derivative |
| | | (Addid ® 900, Wacker-Chemie), |
| 2 | pbw | corrosion inhibitor |
| | | (Irgacor ® 153, Ciba-Geigy), |
| 37.75 | pbw | Lonzamon ® AAEMA, |
| 15 | pbw | iron phosphide as in Example 1, |
| 5.5 | pbw | Irgacure ® 1850, and |
| 5.5 | pbw | Irgacure ® 184. |

Upon coating and curing as in Example 1, a corrosion-protected steel sheet with similar properties as in this example was obtained.

### EXAMPLE 3

The procedure was as in Example 1, but there was used a coating compound of the following composition:

| | | |
|---|---|---|
| 20 | pbw | of an acrylic ester of an aromatic epoxy resin |
| | | (Laromer ® LR 8986, BASF AG), |
| 20 | pbw | of the aliphatic urethane acrylate indicated in Example 2 |
| | | (Viaktin ® VTE 6171), |
| 0.5 | pbw | of a polyether-modified polydimethyl siloxane |
| | | (Byk ® 333, Byk Chemicals), |
| 0.1 | pbw | of a polysiloxane |
| | | (Dow Corning 163 Additive, Dow Corning Corp., USA), |
| 20.6 | pbw | Lonzamon ® AAEMA, |
| 10 | pbw | Magnetschwarz ® S 0045, |
| 15 | pbw | Ferrophos ® HRS 2132, |
| 3.8 | pbw | K-White ® 105, |
| 2 | pbw | Irgacure ® 1850, and |
| 8 | pbw | Irgacure ® 184. |

The coating had a thickness of 4 μm. Irradiation was effected in air with the same light source as in Example 1. The rate of passage was 4 m/min. Substantially the same results were achieved as in Example 1.

### EXAMPLE 4

The procedure was as in Example 1, but the coating mixture was replaced by the following mixture:

| | | |
|---|---|---|
| 22 | pbw | of an aromatic epoxy resin esterified with acrylic acid |
| | | (Viaktin ® EP 86, 75% in tripropylene glycol |
| | | diacrylate, Vianova), |
| 10 | pbw | Viaktin ® VTE 6171, as in Example 2, |
| 0.5 | pbw | Byk ® 333, |
| 0.05 | pbw | of a silicone-free surface-active polymer |
| | | (Byk ® 053), |
| 27.45 | pbw | Lonzamon ® AAEMA, |
| 8 | pbw | Magnetschwarz ® S 0045, |
| 12 | pbw | Ferrophos ® HRS 2132, |
| 3 | pbw | K-White ® 105 |
| 1 | pbw | Irgacure ® 1850, and |
| 16 | pbw | Irgacure ® 184. |

The results were similar to those in the preceding examples.

### EXAMPLE 5

The procedure was as in Example 1, but coating was performed with the following mixture.

| | | |
|---|---|---|
| 17 | pbw | Laromer ® LR 9896, |
| 17 | pbw | Viaktin ® VTE 6171, |
| 0.5 | pbw | Byk ® 333, |
| 0.1 | pbw | Dow Corning 163 Additive, |
| 22.9 | pbw | Lonzamon ® AAEMA, |
| 8 | pbw | Magnetschwarz ® S 0045, |
| 17 | pbw | Ferrophos ® HRS 2132, |
| 3.5 | pbw | K-White ® 105, |
| 2 | pbw | Irgacure ® 1850, and |
| 12 | pbw | Irgacure ® 184. |

The results were comparable to those obtained in Example 1.

### EXAMPLE 6

The procedure was as in Example 1, but coating was performed with the following mixture.

| | | |
|---|---|---|
| 19 | pbw | of a novolak epoxy resin cross-linked with acrylic acid, |
| | | (Ebecryl ® 639 of UCB Chemicals, Belgium, containing |
| | | 60% epoxy resin, 30% trimethylolpropane triacrylate and |
| | | 10% hydroxyethyl methacrylate), |
| 8 | pbw | of an aliphatic urethane acrylate |
| | | (Ebecryl ® IRR 351, UCB Chemicals), |
| 5.5 | pbw | Syntholux ® DRB 227, |
| 3 | pbw | of an unsaturated phosphoric acid ester |
| | | (Additol ® VXL 6219, Vianova Resins) |
| 0.5 | pbw | Byk ® 333, |
| 0.02 | pbw | Dow Corning 163, |
| 0.4 | pbw | Irgacure ® 153, |
| 8,5 | pbw | Magnetschwarz ® S 0045, |
| 13.5 | pbw | Ferrophos ® HRS 2132, |
| 3.5 | pbw | K-White ® 105, |
| 13 | pbw | Irgacure ® 184, |
| 3.25 | pbw | Irgacure ® 651, |
| 1 | pbw | Irgacure ® 1850, |
| 20.83 | pbw | of a hydroxypropyl methacrylate |
| | | (Bisomer ® HPMA, BP Chemicals, Buckingham, GB). |

The results were comparable to those obtained in Example 1.

1-15. (canceled)

16. A method of applying a slidable anticorrosive layer to a metallic substrate, comprising applying a mixture comprising a polymeric organic binder, a low-molecular monomeric liquid compound to be subjected to free-radical polymerization, a compound forming radicals under the influence of actinic radiation, and from at least 10% by weight of a conductive inorganic pigment selected from the group consisting of magnetizable oxides of iron, phosphates of iron, phosphides of iron, phosphates of aluminum, phosphides of aluminum, and graphite coated mica pigments to the surface of a metallic substrate and irradiating the applied mixture with actinic radiation of such an intensity and for such a period that a firm, hard, and sufficiently tough, corrosion-resistant layer is formed, wherein the slidable anticorrosive layer is electroconductive and the electroconductivity of the layer is provided only by said inorganic pigment, wherein the coating mixture is applied to obtain a layer thickness of 2 to 8 microns.

17. A method of applying a slidable anticorrosive layer to a metallic substrate, comprising applying a mixture comprising a polymeric organic binder, a low-molecular monomeric liquid compound to be subjected to free-radical polymerization, a compound forming radicals under the influence of actinic radiation, and from at least 10% by weight of a conductive inorganic pigment selected from the group consisting of magnetizable oxides of iron, phosphates of iron, phosphides of iron, phosphates of aluminum, phosphides of aluminum, and graphite coated mica pigments to the surface of a metallic substrate and irradiating the applied mixture with actinic radiation of such an intensity and for such a period that a firm, hard, and sufficiently tough, corrosion-resistant layer is formed, wherein the slidable anticorrosive layer is electroconductive and the electroconductivity of the layer is provided only by said inorganic pigment, wherein the substrate to be coated is a steel sheet which has previously been zinc-coated, chromatized, pretreated with a composition that is free of chromate, or any combination thereof.

18. The method as claimed in claim 16, wherein said coating and said curing are effected sequentially.

19. A flexible metal sheet which is electrolytically zinc-coated or hot-dip coated or chromatized or pretreated with a composition that is free of chromate and has an organic layer applied thereto, which layer is prepared by the method as claimed in claim 16.

20. A method of applying a slidable anticorrosive layer to a metallic substrate, comprising applying a mixture consisting of a polymeric organic binder, a low-molecular monomeric liquid compound to be subjected to free-radical polymerization, a compound forming radicals under the influence of actinic radiation, and at least 10% by weight of a conductive inorganic pigment selected from the group consisting of magnetizable oxides of iron, phosphates of iron, phosphides of iron, phosphates of aluminum, phosphides of aluminum, and graphite coated mica pigments to the surface of a metallic substrate and irradiating the applied mixture with actinic radiation of such an intensity and for such a period that a firm, hard, and sufficiently tough, corrosion-resistant layer is formed, wherein the slidable anticorrosive layer is electroconductive and the electroconductivity of the layer is provided only by said inorganic pigment, wherein the coating mixture is applied to obtain a layer thickness of 2 to 8 microns.

21. A method of applying a slidable anticorrosive layer to a metallic substrate, comprising applying a mixture consisting of a polymeric organic binder, a low-molecular monomeric liquid compound to be subjected to free-radical polymerization, a compound forming radicals under the influence of actinic radiation, and at least 10% by weight of a conductive inorganic pigment selected from the group consisting of magnetizable oxides of iron, phosphates of iron, phosphides of iron, phosphates of aluminum, phosphides of aluminum, and graphite coated mica pigments to the surface of a metallic substrate and irradiating the applied mixture with actinic radiation of such an intensity and for such a period that a firm, hard, and sufficiently tough, corrosion-resistant layer is formed wherein the slidable anticorrosive layer is electroconductive and the electroconductivity of the layer is provided only by said inorganic pigment and wherein the substrate to be coated is a steel sheet which has previously been zinc-coated, chromatized, pretreated with a composition that is free of chromate or any combination thereof.

22. The method as claimed in claim 20, wherein said coating and said curing are effected sequentially.

23. A flexible metal sheet which is electrolytically zinc-coated or hot-dip coated or chromatized or pretreated with a composition that is free of chromate and has an organic layer applied thereto, which layer is prepared by a method comprising applying a mixture consisting of a polymeric organic binder, a low-molecular monomeric liquid compound to be subjected to free-radical polymerization, a compound forming radicals under the influence of actinic radiation, and at least 10% of a conductive inorganic pigment selected from the group consisting of magnetizable oxides of iron, phosphates of iron, phosphides of iron, phosphates of aluminum, phosphides of aluminum, and graphite coated mica pigments to the surface of a metallic substrate and irradiating the applied mixture with actinic radiation of such an intensity and for such a period that a firm, hard, and sufficiently tough, corrosion-resistant layer is formed, wherein the slidable anticorrosive layer is electroconductive and the electroconductivity of the layer is provided only by said inorganic pigment.

24. A method of applying a slidable anticorrosive layer to a metallic substrate, comprising applying a mixture comprising a polymeric organic binder, a low-molecular monomeric liquid compound to be subjected to free-radical polymerization, a compound that forms radicals under the influence of actinic radiation, and at least 10% by weight of a conductive inorganic selected from the group consisting of oxides of iron, phosphates of iron, phosphides of iron, oxides of aluminum, phosphates of aluminum, phosphides of aluminum, and graphite coated mica pigments to the surface of a metallic substrate and irradiating the applied mixture with actinic radiation of such an intensity and for such a period that a firm, hard, and sufficiently tough, corrosion-resistant layer is formed, wherein the slidable anticorrosive layer is electroconductive and the electroconductivity of the layer is provided only by said inorganic pigment, wherein the coating mixture is applied to obtain a layer thickness of 2 to 8 microns.

25. A method of applying a slidable anticorrosive layer to a metallic substrate, comprising applying a mixture comprising a polymeric organic binder, a low-molecular monomeric liquid compound to be subjected to free-radical polymerization, a compound that forms radicals under the influence of actinic radiation, and at least 10% by weight of a conductive inorganic selected from the group consisting of oxides of iron, phosphates of iron, phosphides of iron, oxides of aluminum, phosphates of aluminum, phosphides of aluminum, and graphite coated mica pigments to the surface of a metallic substrate and irradiating the applied mixture with actinic radiation of such an intensity and for such a period that a firm, hard, and sufficiently tough, corrosion-resistant layer is formed, wherein the slidable anticorrosive layer is electroconductive and the electroconductivity of the layer is provided only by said inorganic pigment and wherein the substrate to be coated is a steel sheet which has previously been zinc-coated, chromatized, pretreated with a composition that is free of chromate, or any combination thereof.

26. A method of applying a slidable anticorrosive layer to a metallic substrate, comprising applying a mixture comprising a polymeric organic binder, a low-molecular monomeric liquid compound to be subjected to free-radical polymerization, a compound that forms radicals under the influence of actinic radiation, and at least 10% by weight of a conductive inorganic selected from the group consisting of oxides of iron, phosphates of iron, phosphides of iron, oxides of aluminum, phosphates of aluminum, phosphides of aluminum, and graphite coated mica pigments to the surface of a metallic substrate and irradiating the applied mixture with actinic radiation of such an intensity and for such a period that a firm, hard, and sufficiently tough, corrosion-resistant layer is formed, wherein the slidable anticorrosive layer is electroconductive and the electroconductivity of the layer is provided only by said inorganic pigment, and wherein said coating and said curing are effected in one step.

27. A flexible metal sheet which is electrolytically zinc-coated or hot-dip coated or chromatized or pretreated with a composition that is free of chromate and has an organic layer applied thereto, which layer can be obtained by a method comprising applying a mixture comprising a polymeric organic binder, a low-molecular monomeric liquid compound to be subjected to free-radical polymerization, a compound that forms radicals under the influence of actinic radiation, and from at least 10% by weight of a conductive inorganic selected from the group consisting of oxides of iron, phosphates of iron, phosphides of iron, oxides of aluminum, phosphates of aluminum, phosphides of aluminum, and graphite coated mica pigments to the surface of a metallic substrate and irradiating the applied mixture with actinic radiation of such an intensity and for such a period that a firm, hard, and sufficiently tough, corrosion-resistant layer is formed, wherein the slidable anticorrosive layer is electroconductive and the electroconductivity of the layer is provided only by said inorganic pigment.

28. A method of applying a slidable anticorrosive layer to a metallic substrate, comprising applying a mixture comprising a polymeric organic binder, a low-molecular monomeric liquid compound to be subjected to free-radical polymerization, a compound forming radicals under the influence of actinic radiation, and at least 10% by weight of a conductive inorganic pigment selected from the group consisting of magnetizable oxides of iron, phosphates of iron, phosphides of iron, phosphates of aluminum, phosphides of aluminum, and graphite coated mica pigments to the surface of a metallic substrate and irradiating the applied mixture with actinic radiation of such an intensity and for such a period that a firm, hard, and sufficiently tough, corrosion-resistant layer is formed, wherein the layer is electroconductive and the electroconductivity is provided only by said conductive inorganic pigment.

29. The method as claimed in claim 28, wherein the substrate to be coated is a steel sheet which has previously been zinc-coated, chromatized, pretreated with a composition that is free of chromate or any combination thereof, wherein the coating mixture is applied to obtain a layer thickness of 2 to 8 μm.

30. The method as claimed in claim 28, wherein said coating and said curing are effected sequentially and wherein the coating mixture is applied to obtain a layer thickness of 2 to 8 μm.

31. A flexible metal sheet which is electrolytically zinc-coated or hot-dip coated or chromatized or pretreated with a composition that is free of chromate and has an organic layer applied thereto, which layer is prepared by the method as claimed in claim 28.

32. A method of applying a slidable anticorrosive layer to a metallic substrate, comprising applying a mixture consisting of a polymeric organic binder, a low-molecular monomeric liquid compound to be subjected to free-radical polymerization, a compound forming radicals under the influence of actinic radiation, and at least 10% by weight of a conductive inorganic pigment selected from the group consisting of magnetizable oxides of iron, phosphates of iron, phosphides of iron, phosphates of aluminum, phosphides of aluminum, and graphite coated mica pigments to the surface of a metallic substrate and irradiating the applied mixture with actinic radiation of such an intensity and for such a period that a firm, hard, and sufficiently tough, corrosion-resistant layer is formed, wherein the layer is electroconductive and the electroconductivity is provided only by said conductive inorganic pigment.

33. The method as claimed in claim 32, wherein the substrate to be coated is a steel sheet which has previously been zinc-coated, chromatized, pretreated with a composition that is free of chromate or any combination thereof, and wherein the coating mixture is applied to obtain a layer thickness of 2 to 8 microns.

34. The method as claimed in claim 32, wherein said coating and said curing are effected sequentially and wherein the coating mixture is applied to obtain a layer thickness of 2 to 8 microns.

35. A flexible metal sheet which is electrolytically zinc-coated or hot-dip coated, chromatized, pretreated with a composition that is free of chromate, or any combination thereof and has an organic layer applied thereto, which layer is prepared by the method as claimed in claim 63.

36. A method of applying a slidable anticorrosive layer to a metallic substrate, comprising applying a mixture comprising a polymeric organic binder, a low-molecular monomeric liquid compound to be subjected to free-radical polymerization, a compound that forms radicals under the influence of actinic radiation, and least 10% by weight of a conductive inorganic selected from the group consisting of oxides of iron, phosphates of iron, phosphides of iron, oxides of aluminum, phosphates of aluminum, phosphides of aluminum, and graphite coated mica pigments to the surface of a metallic substrate and irradiating the applied mixture with actinic radiation of such an intensity and for such a period that a firm, hard, and sufficiently tough, corrosion-resistant layer is formed, wherein the layer is electroconductive and the electroconductivity is provided only by said inorganic pigment.

37. The method as claimed in claim 36, wherein the substrate to be coated is a steel sheet which has previously been zinc-coated, chromatized, pretreated with a composition that is free of chromate or any combination thereof, and wherein the mixture is applied to obtain a layer thickness of 2 to 8 microns.

38. The method as claimed in claim 36, wherein said coating and said curing are effected sequentially in one step and wherein the mixture is applied to obtain a layer thickness of 2 to 8 microns.

39. A flexible metal sheet which is electrolytically zinc-coated or hot-dip coated, chromatized, pretreated with a composition that is free of chromate or any combination thereof and has an organic layer applied thereto, which layer can be obtained by the method as claimed in claim 36.

40. The method as claimed in claim 23, wherein said inorganic pigment comprises magnetizable iron oxide.

41. The method as claimed in claim 32, wherein the conductive inorganic pigment comprises magnetizable iron oxide.

42. The method as claimed in claim 28, wherein the conductive inorganic pigment comprises magnetizable iron oxide.

43. The method of claim 16, wherein the layer is electroconductive, wherein, the pigment consists of magnetizable iron oxide.

44. The method of claim 16, wherein the mixture comprises from at least 20% by weight of said conductive inorganic pigment.

45. The method of claim 16, wherein the mixture comprises from at least 20% to at least 40% by weight of said conductive inorganic pigment.

46. The method of claim 17, wherein the mixture comprises at least 20% by weight of said conductive inorganic pigment.

47. The method of claim 17, wherein the mixture comprises from at least 20% to at least 40% by weight of said conductive inorganic pigment.

48. The method of claim 20, wherein the mixture comprises at least 20% by weight of said conductive inorganic pigment.

49. The method of claim 20, wherein the mixture comprises from at least 20% to at least 40% by weight of said conductive inorganic pigment.

50. The method of claim 21, wherein the mixture comprises from at least 20% by weight of said conductive inorganic pigment.

51. The method of claim 21, wherein the mixture comprises from at least 20% to at least 40% by weight of said conductive inorganic pigment.

52. The method of claim 22, wherein the mixture comprises from at least 20% by weight of said conductive inorganic pigment.

53. The method of claim 22, wherein the mixture comprises from at least 20% to at least 40% by weight of said conductive inorganic pigment.

54. The method of claim 24, wherein the mixture comprises from at least 20% by weight of said conductive inorganic pigment.

55. The method of claim 24, wherein the mixture comprises from at least 20% to at least 40% by weight of said conductive inorganic pigment.

56. The method of claim 25, wherein the mixture comprises from at least 20% by weight of said conductive inorganic pigment.

57. The method of claim 25, wherein the mixture comprises from at least 20% to at least 40% by weight of said conductive inorganic pigment.

58. The method of claim 26, wherein the mixture comprises from at least 20% to at least 40% by weight of said conductive inorganic pigment.

59. The method of claim 26, wherein the mixture comprises at least 20% by weight of said conductive inorganic pigment.

60. The method of claim 27, wherein the mixture comprises from at least 20% by weight of said conductive inorganic pigment.

61. The method of claim 27, wherein the mixture comprises from at least 20% to at least 40% by weight of said conductive inorganic pigment.

62. The method of claim 28, wherein the mixture comprises from at least 20% by weight of said conductive inorganic pigment.

63. The method of claim 28 wherein the mixture comprises from at least 20% to at least 40% by weight of said conductive inorganic pigment.

64. The method of claim 32, wherein the mixture comprises from at least 20% by weight of said conductive inorganic pigment.

65. The method of claim 32, wherein the mixture comprises from at least 20% to at least 40% by weight of said conductive inorganic pigment.

66. The method of claim 36, wherein the mixture comprises from at least 20% by weight of said conductive inorganic pigment.

67. The method of claim 36, wherein the mixture comprises from at least 20% to at least 40% by weight of said conductive inorganic pigment.
